(19) United States
(12) Patent Application Publication
(10) Pub. No.: US 2010/0239796 A1
(43) Pub. Date: Sep. 23, 2010

(54) LAP SEALABLE LAMINATE AND PACKAGING MADE THEREFROM

(76) Inventors: Joseph Donald GAGNE, Holyoke, MA (US); David Hoyt Bostian, Columbus, WI (US)

Correspondence Address: Muncy, Geissler, Olds & Lowe, PLLC, 4000 Legato Road, Suite 310, FAIRFAX, VA, 22033, US

(21) Appl. No.: 12/724,111

(22) Filed: Mar. 15, 2010

Related U.S. Application Data
(60) Provisional application No. 61/202,651, filed on Mar. 23, 2009.

(51) Int. Cl. B32B 1/02; B32B 27/32; B32B 27/30; B32B 27/36; B32B 27/10; B32B 27/00; B32B 27/08

(52) U.S. Cl. 428/34.3; 428/516; 428/523; 428/422; 428/483; 428/513; 428/35.2; 428/35.4; 428/476.9

(57) ABSTRACT

A lap sealable laminate is provided comprised of an oriented polypropylene film layer on one side of the laminate, and a polyolefin elastomer-modified polyethylene sealant film forming an opposing side of the laminate, as well as a flexible pouch formed from the lap sealable laminate.

This application claims priority of U.S. Provisional Application No. 61/202,651 filed on Mar. 23, 2009, under 35 U.S.C. §119(e), the entire contents of which are hereby incorporated by reference.

### BACKGROUND OF THE PRESENT INVENTION

The present invention is directed to a lap sealable laminate and packaging made therefrom.

Packaging laminates have been produced for many years comprised of multiple polyolefin film layers. Such laminates have many uses, but have found particular use in the food industry for food packaging in the formation of flexible pouches. Exemplary polyolefins include both polyethylene and polypropylene, although a number of different polyolefins have been employed. Oriented polyolefin layers such as oriented polypropylene have been used with advantage. Such polyolefins have been used in admixture with other polymers. Optionally, barrier layers have also been employed comprised of a variety of materials capable of serving a gas or moisture barrier function. Such materials have included, but are not limited to, materials such as EVOH, Nylon or high density polyethylene (HDPE).

While such laminates have been used with advantage, several disadvantages arise. For instance, such laminates are typically formed into a cylindrical shape to form a flexible pouch, with the adjacent edges adhered together by means of a fin seal. In a fin seal, opposing edges of the laminate are folded upwardly such that opposing interior surfaces of the barrier layer are caused to face and be adhered to each other. Fin seals have conventionally been required to seal a laminate having an inner polyethylene layer and an outer oriented polypropylene layer as the two layers are not easily heat sealed to each other.

As a result, it has frequently been necessary to use fin seals for such laminates, whereby adjacent polyethylene layers are heat-sealed to one another. However, fin seals are not preferred as they require more material, create areas of the package prone to leaking, and are not visually pleasing.

When a lap seal is instead employed on a polyethylene to oriented polypropylene laminate, the resulting seal strength is unsatisfactory, and higher seal initiation temperatures are required.

It is thus desirable to provide an improved sealable laminate that enables enhanced bonding to occur when the laminate includes a polyethylene layer and an oriented polypropylene layer on opposite sides.

It is also desirable to provide an improved sealable laminate that enables suitable bonding to occur at lower temperatures.

It is further desirable to provide a laminate material comprised of a polyethylene layer and an oriented polypropylene layer on opposite sides which may be bonded by means of a lap seal.

### OBJECTS AND SUMMARY OF THE INVENTION

It is accordingly an object of the present invention to provide an improved lap sealable laminate suitable for use in the production of flexible pouches.

It is further an object of the present invention to provide a lap-sealable laminate which may be sealed at desirably lower processing temperatures than conventionally employed.

It is further an object of the present invention to provide a lap-sealable laminate which may be sealed with a seal of improved strength.

It is still yet further an object of the present invention to provide a flexible pouch formed from the lap-sealable laminate of the present invention.

In accordance with the present invention, there is thus provided a lap sealable laminate comprised of an oriented polypropylene film layer on one side of the laminate, and a polyolefin elastomer-modified polyethylene sealant film forming an opposing side of the laminate.

In accordance with another embodiment of the present invention, there is provided a flexible pouch comprised of a laminate, wherein the laminate is comprised of an oriented polypropylene film layer on one side of the laminate, and a polyolefin elastomer-modified polyethylene sealant film forming an opposing side of the laminate, whereby the flexible pouch includes a lap seal between overlapping opposing edges of the laminate whereby overlapping portions of the polyolefin elastomer-modified polyethylene sealant film and the oriented polypropylene film are heat-sealed to each other to form the lap seal.

### BRIEF DESCRIPTION OF THE DRAWINGS

The present invention is described in conjunction with the following drawings:

FIG. 1 is a cross-sectional view of one embodiment of the laminate of the present invention.

FIG. 2 is a cross-sectional view of another embodiment of the laminate of the present invention.

FIG. 3 is a perspective view of a lap seal in accordance with the present invention.

FIG. 4 is a perspective view of a flexible pouch of the present invention.

FIG. 5 is a perspective view of one method of forming a flexible pouch in accordance with the present invention.

### DETAILED DESCRIPTION OF THE PRESENT INVENTION

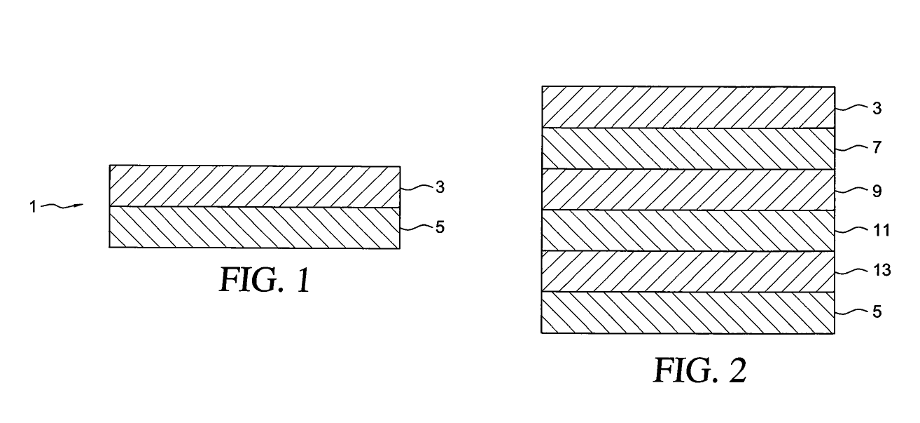

The lap sealable laminate of the present invention is comprised of an oriented polypropylene film on one side of the laminate, and a polyolefin elastomer-modified polyethylene film layer forming an opposing outer surface of the laminate. The invention will be described in conjunction with FIGS. 1-5.

The propylene polymer may be formed from a monomer represented by the formula H₂C═CR₁R₂ wherein, independently, R₁ may be H or a C₂-C₆ alkyl group, and R₂ is H, a C₂-C₆ alkyl group, or a C(O)OR₃ group wherein R₃ is H or a C₂-C₆ alkyl group. The identity of the R groups is not critical to practice of the present invention. Further, for purposes of the present invention, the propylene polymer is intended to mean a propylene homopolymer, or a copolymer of propylene and a suitable comonomer.

The comonomer may comprise a C₄-C₂₀ olefin monomer. The comonomer may be linear, branched or cyclic, and is preferably an α-olefin. Exemplary comonomers include but are not limited to butene, isobutylene, pentene, isopentene, cyclopentene, hexane, isohexene, cyclohexene, heptene, isoheptene, cycloheptene, oxtene, isooctene, cyclooctene, nonene, cyclononene, docene, isodecene, dodecene, 4-methyl-pentene-1,3-methyl-pentene-1,3,5,5-trimethyl-hexene-1, etc.

Additional monomers may be present in addition to the above C₄₋₂₀ olefin monomers, such as C₄₋₂₀ linear, cyclic or branched dienes or trienes, and any styrenic monomer such as trienes, or other styrenic monomers such as styrene, α-methyl styrene, or p-methyl styrene. Exemplary monomers include but are not limited to butadiene, pentadiene, cyclopentadiene, hexadiene, cyclohexadiene, heptadiene, octadiene, nonadiene, norbornene, vinyl norbornene, ethylidene, norbornene, isoprene, and heptadiene.

The proportion of the propylene in the copolymer is preferably at least 50%, more preferably at least 75%, still more preferably at least 85%, and most preferably at least 95% by weight of the copolymer.

The polypropylene film layer is an oriented polypropylene film. In connection with the present invention, an oriented polypropylene film is a film in which the propylene polymer has been aligned in one or both of the transverse or machine directions. If oriented in both directions, the polymer film is deemed to be biaxially oriented.

The film will have an orientation ratio, which is the ratio of the extent to which the film has been expanded. Typically, the film is oriented in either the machine or transverse direction in a ratio of up to 15, such as within a ratio of between 5 and 9. The film may be oriented in either the same or different ratios in each direction or, as noted above, only in one direction. Such films are well known to those skilled in the art.

The polyethylene sealant within which the polyolefin elastomer is incorporated may be comprised of a suitable heat sealable polyethylene such as a low density polyethylene (LDPE), linear low density polyethylene (LLDPE), linear medium density polyethylene (LMDPE), linear very low density polyethylene (VLDPE), linear ultra low density polyethylene (ULDPE), Metallocene linear low density polyethylene (MLLDPE), Polyolefin Plastomer Polyethylene (POP), high density polyethylene (HDPE), or the like. Of the above, linear low density polyethylene and/or Polyolefin Plastomer are preferred.

Alternatively, copolymers of ethylene may be employed as the polyethylene layer, wherein the copolymer contains up to about 50% by weight of a C₃-C₂₀ olefin comonomer. The identity of the C₃-C₂₀ comonomer is not critical to practice of the claimed invention, and preferably comprises linear, branched or cyclic olefins, and is preferably an α-olefin. Exemplary comonomers include but are not limited to propylene, butene, isobutylene, pentene, isopentene, cyclopentene, hexane, isohexene, cyclohexene, heptene, isoheptene, cycloheptene, oxtene, isooctene, cyclooctene, nonene, cyclononene, docene, isodecene, dodecene, 4-methyl-pentene-1,3-methyl-pentene-1,3,5,5-trimethyl-hexene-1, vinyl acetate, etc.

Additional monomers may be present in addition to the above C₃₋₂₀ olefin monomers, such as C₃₋₂₀ linear, cyclic or branched dienes or trienes, and any styrenic monomer such as trienes, or other styrenic monomers such as styrene, α-methyl styrene, or p-methyl styrene. Exemplary monomers include but are not limited to butadiene, pentadiene, cyclopentadiene, hexadiene, cyclohexadiene, heptadiene, octadiene, nonadiene, norbornene, vinyl norbornene, ethylidene, norbornene, isoprene, and heptadiene.

Polyethylene Plastomers may also be used as the polyethylene sealant layer.

Polyethylene Plastomers are typically homopolymers of ethylene, or copolymers of ethylene with higher alpha-olefins having from 3 to 10 carbon atoms, such as 1-butene, 1-hexene, 1-octene, etc. Such plastomers are available from Dow Plastics under various product designations as well as under the trademark AFFINITY™. Other suitable plastomers are available from Exxon under the trademark EXACT™. The EXACT™ plastomers have density and peak melting point ranges that are similar to the AFFINITY™ plastomers.

The polyethylene plastomer generally has a density of about 0.870-0.935 g/cm.³, more preferably 0.870-0.910 g/cm³, and a melt index of 0.8-7.5 g/10 min at 2.16 kg loading 190° C. in accordance with ASTM D1238. The polyethylene plastomer is distinguished from LLDPE, VLDPE and an ethylene/alpha-olefin elastomer in Mw/Mn and/or I₁₀/I₂. LLDPE is as an ethylene/alpha-olefin (with 4-8 carbon atoms) copolymer having a density of greater than 0.910 g/cm³ but not greater than 0.925 g/cm³. VLDPE is an ethylene/alpha-olefin (with 4-8 carbon atoms) copolymer having a density of 0.890-0.910 g/cm³.

The laminate of the present invention may be comprised of multiple layers, such as, for example, 2 to 8 layers, including one or more layers each of the polypropylene, polyethylene, and barrier layers such as EVOH layers.

Exemplary internal layers within the laminate include but are not limited to foil, nylon, polyvinylidene chloride, polyethylene terephthalate (PET), oriented polypropylene, ethylene/vinyl acetate copolymers, paper, ethylene/acrylic acid copolymers, ethylene/methacrylic acid copolymers, EVOH, paper, polyethylene, metallized polyethylene terephthalate, or oriented polypropylene (OPP), etc. The specific identity of such layers is not critical to the practice of the present invention, but may be determined based on the specific utility contemplated for the laminate.

A preferred barrier material comprises an ethylene/vinyl alcohol (EVOH) copolymer. EVOH generally has an ethylene content of from 15-70 mol %, preferably from 25-55 mol %, which has a degree of hydrolysis for the vinyl ester moiety of from 85-99%, and preferably 95% or greater. If the ethylene content of the EVOH copolymer is greater than about 70 mol %, the gas barrier properties exhibited thereby are diminished, as is also exhibited if the degree of hydrolysis is less than about 95%.

For purposes of the present invention, the term barrier layer is intended to mean that the layer is impermeable to gases or liquids. In particular, the layer is impermeable to oxygen.

The EVOH copolymer may further be copolymerized with comonomers such as but not limited to propylene, butylene, unsaturated carboxylic acid (such as methacrylic acid), an ester of an unsaturated carboxylic acid (such as methyl(meth)acrylate), vinylpyrrolidone, etc. Such additional monomers may be present in amounts which do not otherwise disadvantageously affect the desired gas barrier properties of the EVOH film.

It is also within the scope of the present invention to employ two or more types of EVOH polymers in the EVOH film, as well as various conventional additives such as heat stabilizers, UV light absorbers, antioxidants, coloring agents, fillers, etc., in amounts which do not affect the desired properties of the EVOH layer.

EVOH polymers are well known in the art and commercially readily available. See, for example, U.S. Pat. Nos. 3,510,464; 3,560,461; 3,847,845; 3,595,740; and 3,585,177, which describe well-known methods for the production of such polymers.

In any event, for purposes of the present invention, one outer layer is comprised of the oriented polypropylene layer, and another outer layer is comprised of a polyolefin elastomer-modified polyethylene layer, irrespective of the identity of any internal or intermediate layers. Any additional layers are added to the laminate by suitable bonding means, such as adhesive lamination (where a suitable adhesive such as a urethane adhesive is used to bond the respective layers together), or by extrusion or co-extrusion lamination. Such methods are known to those skilled in the art, and a suitable bonding method can readily be determined that will enable a satisfactorily bonded laminate to be formed.

The respective layers may be of any suitable thickness, as the thickness of the respective layers is not critical to practice of the present invention. By way of example, the thickness of the individual film layers in the laminate may range from about 1 μm to about 150μ, and more preferably, from about 7 μm to about 100μ. However, any suitable thickness may be employed with advantage.

The present invention also encompasses those embodiments where one or more of the films which comprise the laminate are oriented in one or more of the transverse or machine directions in addition to the oriented polypropylene layer. For instance, non-oriented polyethylene and/or polypropylene films can be coated onto oriented polyethylene and/or polypropylene (or polyolefin) layers.

The laminate of the present invention can be formed by any suitable method. Exemplary methods which are suitable for formation of the laminate include extrusion, co-extrusion, extrusion coating, adhesive lamination, extrusion lamination, blowing and casting.

In accordance with the present invention, the heat-sealable polyethylene sealing layer is employed to form an adhesive seal with the oriented polypropylene layer when a lap seal is formed during the formation of packaging, or for some other purpose. It has been surprisingly and unexpectedly found that a polyethylene sealing layer modified with a polyolefin elastomer enables an adhesive seal to be formed with the oriented polypropylene layer having enhanced adhesive properties, as well as having the property of enabling adhesion to be initiated at temperatures lower than exhibited or required by the prior art.

The adhesive seal layer is comprised of the polyolefin elastomer as one component, in admixture with a heat-sealable polyethylene polymer. The polyethylene sealant polymer may be, for example, a polyethylene plastomer, or a polyethylene sealant material, or a combination of the two.

Preferably, the polyolefin elastomer comprises a polymer wherein the ethylene monomers are polymerized with an alpha-olefin having from 4 to 10 carbon atoms such that the resulting polymer composition has a narrow molecular weight distribution (Mw/Mn), homogeneous branching and controlled long chain branching. Suitable alpha-olefins include, but are not limited to, 1-octene, 1-butene, 1-hexene and 4-methyl-pentene.

Exemplary polymers include those which are known in the art as “Metallocene”, “constrained geometry” or “single-site” catalyzed polymers such as those described in U.S. Pat. No. 5,472,775; U.S. Pat. No. 5,451,450; U.S. Pat. No. 5,539,124; and U.S. Pat. No. 5,554,775.

The Metallocene process generally uses a Metallocene catalyst which is activated, i.e. ionized, by a co-catalyst. Examples of Metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, among others.

Numerous other Metallocene catalysts, single site catalysts, constrained geometry catalysts and/or comparable catalyst systems are known in the art; see for example, The Encyclopedia of Chemical Technology, Kirk-Othemer, Fourth Edition, vol. 17, Olefinic Polymers, pp. 765-767 (John Wiley & Sons 1996.

The polyethylene sealant layer may comprise with advantage a combination of one or more of the polyethylene components (such as a low density polyethylene (LDPE), linear low density polyethylene (LLDPE), linear medium density polyethylene (LMDPE), linear very low density polyethylene (VLDPE), linear ultra low density polyethylene (ULDPE), Metallocene linear low density polyethylene (MLLDPE), high density polyethylene (HDPE), or the like), together with a polyethylene plastomer.

When used in combination, typical weight ratios of the polyethylene component and the polyethylene plastomer range from 95:5 to 5:95, although the particular ratio is not critical. The amount of plastomer which is present is determined by the contemplated end use. That is, the presence of higher amounts of the plastomer in the polyethylene film will decrease the initiation temperature of the film for purposes of bonding, but may also detract from the physical properties exhibited by the film. It is thus desirable to provide sufficient plastomer to achieve a desired balance of physical properties.

It has also been found to be useful to incorporate a Polypropylene Plastomer into the polyethylene sealing layer in order to enhance the compatibility of the sealing layer to the polypropylene layer during bonding. The Polypropylene Plastomer may be used in conjunction with a Polyethylene Plastomer, or separately therefrom, upon admixture with the polyethylene sealing layer.

When so used, the polypropylene plastomer will generally be present in the polyethylene sealing layer in an amount of from about 1 to about 25% by weight, although the amount may vary depending upon the desired properties desired for the laminate.

Again, the amount of the polypropylene plastomer and/or polyethylene plastomer which is employed in admixture with the polyethylene sealing component to form the sealing film will depend to a certain extent upon the desired end use of the laminate, since not only will the presence of the polypropylene plastomer will enhance the compatibility for purposes of bonding to the oriented polypropylene layer, but the presence of the plastomer will change the physical properties of the polyethylene film.

Polyolefin Elastomers are typically copolymers of propylene and ethylene. Such elastomers are available from Mitsui under various product designations, as well as under the trademark NOTIO™, and from Exxon under various product designations as well as under the trademark VISTAMAXX™.

The polyolefin elastomer/polyethylene polymer blend which forms an outer layer of the laminate may be formed by in any suitable manner known to those skilled in the art including blown or cast extrusion or co-extrusion, or extrusion coating. The polyolefin elastomer will generally comprise from 1 to 50% by weight of the total mixture in order to enable the desired advantages to be achieved, preferably from about 5 to 25% by weight.

The laminate of the present invention may be used in a number of applications. The laminate finds particular utility in the packaging art, such as multilayer packaging consisting of shrink films and barrier shrink applications, packages formed via form/fill/seal steps, cook-in package foods, liners, etc.

As depicted in FIG. 1, the laminate of the present invention 1 in its simplest form comprises one outer layer 3 of an oriented polypropylene film, and an opposing outer layer of a polyolefin elastomer-modified polyethylene film 5.

As depicted in FIG. 2, the laminate may further include, by way of example, multiple layers 7, 9, 11, and 13 intermediate the outer layers.

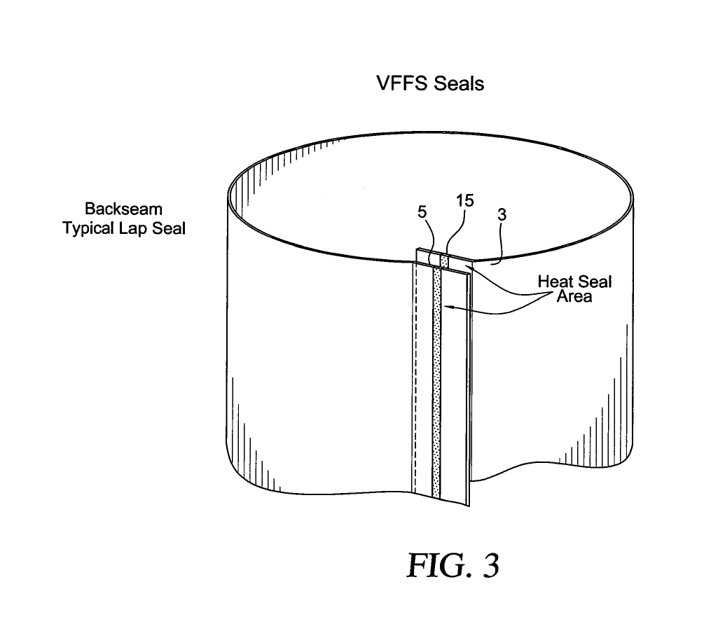

FIG. 3 depicts a typical lap seal 15 used to form a flexible pouch enclosure, with the overlapping surfaces of the inner polyolefin elastomer-modified polyethylene layer 5 and the outer oriented polypropylene layer 3 being shown to be in position for heat sealing together.

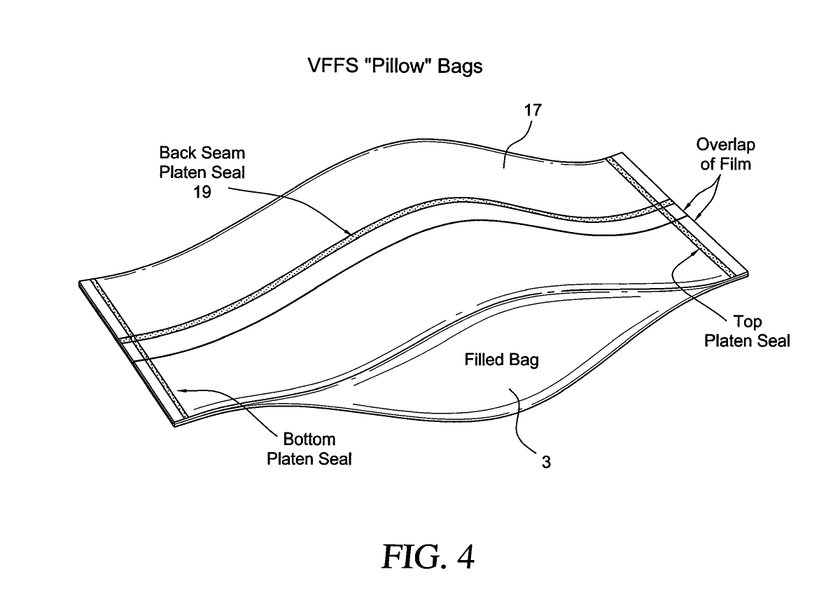

FIG. 4 depicts a typical configuration for a flexible pouch (or pillow bag) 17 wherein a lap seal 19 is shown to extend along the longitudinal extent of the pouch or bag. The outer layer 3 of the pouch or bag comprises the oriented polypropylene layer of the laminate of the present invention.

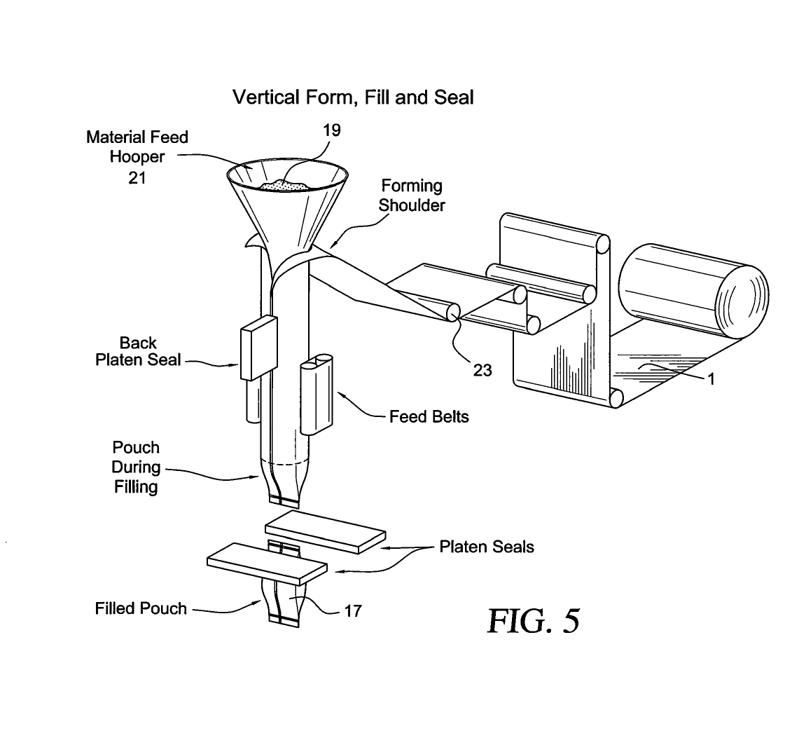

FIG. 5 depicts the “form, fill and seal” method of producing a flexible, filled pouch using the laminate of the present invention. In FIG. 5, material 19 to be filled into the pouch 17 is fed into hopper 21, the laminate 1 of the present invention is fed from rollers 23 from a feed source (not shown) to a forming means wherein the laminate is formed into a cylinder and a lap seal formed along the longitudinal edge of cylinder. The cylinder is filled with the filling material, top and bottom platen seals formed to close the pouch or bag, and the end of the cylinder cut. The manner by which the laminate of the present invention may be used to form a pouch or bag is well known to one skilled in the art.

The invention is further described in conjunction with the following Examples.

### EXAMPLES

In order to demonstrate the advantages of the present invention, the following comparisons were conducted.

Lap sealant strengths were measured between oriented polypropylene and a polyethylene sealing sheet. In one embodiment, the sealing sheet comprised a mixture of LLPE and a polypropylene plastomer (in a weight ratio of 1:3.25 as the “standard sealant”), and in a second embodiment, the sealing sheet comprised a mxture of LLPE, a polyethylene plastomer and a polypropylene elastomer (in a weight ratio of 20:65:15 as the “modified sealant”).

Lap seals were formed between the respective seal sheets and an oriented polypropylene by thermal heat sealing. Once formed, the lap seal strength of each lap seal was determined according to the method of Tensile Testing across the seal (ASTM D882). The results of the respective tests are summarized in the following Table:

TABLE 1

| | Standard | Standard | Modified | Modified |
|---|---|---|---|---|
| | Sealant | Sealant | Sealant | Sealant |
| | Strength | Strength | Strength | Strength |
| Temp ° F. | (lb/in) | (lb/in) | (lb/in) | (lb/in) |
| 230 | | | 0.55 | 0.78 |
| 240 | | | 1.21 | 1.17 |
| 250 | | | 1.37 | 1.39 |
| 260 | | | 1.89 | 1.75 |
| 270 | | | 1.83 | 1.83 |
| 280 | | | 1.88 | 1.66 |
| 290 | 0.17 | 0.15 | 2.18 | 1.95 |
| 300 | 0.23 | 0.23 | 2.15 | 2.06 |
| 310 | 0.29 | 0.35 | 2.34 | 2.34 |
| 320 | 0.56 | 0.83 | 1.78 | 1.56 |
| 330 | 1.28 | 1.27 | 0.88 | 1.22 |
| 340 | 1.70 | 2.32 | 1.93 | 2.45 |
| 350 | 2.31 | 2.30 | 2.63 | 2.65 |
| 360 | 2.73 | 2.89 | 2.89 | 3.02 |

Note:
Seal conditions: 40 psi, 1 second dwell, backed with PET
DOWLEX LLDPE, AFFINITY Polyethylene Plastomer, and NOTIO Polypropylene Elastomer were used in the above comparisons.

As a result of the above tests as summarized above, it is clear that the inclusion of a minor amount of polypropylene elastomer in the standard seal sheet significantly reduces the initiation temperature (i.e., the temperature at which a strong bond forms between the respective layers that is difficult to separate) from about 290 of to about 230° F. The formation of a lap seal between the polyethylene-based seal sheet and the oriented polypropylene sheet is also enhanced by the presence of the polypropylene elastomer in the seal sheet as the seal sheet is made to be more compatible with the oriented polypropylene layer. Thus, not only is the initiation temperature reduced, but the relative strength of the resulting bond between the respective layers is enhanced.

This result is also an advantage in comparison to that which is achieved with respect to the use of an ethylene elastomer instead of a polypropylene elastomer. In such an instance, it is found that while the initiation temperature is significantly reduced, the resulting bond is 3-4 times better with respect to the use of the polypropylene elastomer than with the polyethylene elastomer.

The above description is not intended to be limiting to the intended scope of the invention, and various modifications may be made thereto without departing from the scope of the invention.

What is claimed is:

1. A lap sealable laminate comprised of an oriented polypropylene film layer on one side of said laminate, and a polyolefin elastomer-modified polyethylene sealant film forming an opposing side of said laminate.

2. The laminate of claim 1, wherein said sealant film is comprised of a mixture of said polyolefin elastomer and a polyolefin plastomer.

3. The laminate of claim 1, wherein said sealing layer is comprised of a mixture of a polypropylene elastomer and a polyethylene sealant material.

4. The laminate of claim 1, wherein said oriented polypropylene film is a biaxially oriented polypropylene film.

5. The laminate of claim 1, further comprising a barrier layer intermediate said oriented polypropylene layer and said polyethylene film layer.

6. The laminate of claim 5, wherein said barrier layer is comprised of EVOH.

7. The laminate of claim 1, wherein said polyethylene sealant film comprises a mixture of a polyolefin elastomer and a polyethylene sealant material.

8. The laminate of claim 7, wherein said polyolefin elastomer is a polypropylene elastomer.

9. The laminate of claim 1, wherein said polypropylene polymer is formed from a monomer represented by the formula H₂C═CR₁R₂ wherein, independently, R₁ may be H or a C₂-C₆ alkyl group, and R₂ is H, a C₂-C₆ alkyl group, or a C(O)OR₃ group wherein R₃ is H or a C₂-C₆ alkyl group.

10. The laminate of claim 1, wherein said polyethylene sealant film is comprised of low density polyethylene (LDPE), linear low density polyethylene (LLDPE), linear medium density polyethylene (LMDPE), linear very low density polyethylene (VLDPE), linear ultra low density polyethylene (ULDPE), Metallocene linear low density polyethylene (MLLDPE), high density polyethylene (HDPE), Polyolefin Plastomer (PO), or mixtures thereof.

11. The laminate of claim 1, wherein said polyolefin elastomer is present in said polyethylene sealant film in an amount of from about 1 to about 25 percent by weight.

12. The laminate of claim 1, further including as one or more additional layers intermediate said outer layers foil, nylon, polyvinylidene chloride, polyethylene terephthalate, oriented polypropylene, ethylene/vinyl acetate copolymers, paper, ethylene/acrylic acid copolymers, ethylene/methacrylic acid copolymers, EVOH, paper, and polyethylene.

13. A flexible pouch comprised of a laminate, wherein said laminate is comprised of an oriented polypropylene film layer on one side of the laminate, and a polyolefin elastomer-modified polyethylene sealant film, and forming an opposing side of said laminate, whereby said container includes a lap seal between overlapping opposing edges of the laminate whereby overlapping portions of the polyolefin elastomer-modified sealant film and the oriented polypropylene film are heat-sealed to each other to form said lap seal.

14. The flexible pouch of claim 13, wherein said sealant film is comprised of a mixture of said polyolefin elastomer and a polyolefin plastomer.

15. The flexible pouch of claim 13, wherein said sealing layer is comprised of a mixture of a polypropylene elastomer and a polyethylene sealant material.

16. The flexible pouch of claim 13, wherein said oriented polypropylene film is a biaxially oriented polypropylene film.

17. The flexible pouch of claim 13, further comprising a barrier layer intermediate said oriented polypropylene layer and said polyethylene film layer.

18. The flexible pouch of claim 17, wherein said barrier layer is comprised of EVOH.

19. The flexible pouch of claim 13, wherein said polyethylene sealant film comprises a mixture of a polyolefin elastomer and a polyethylene sealant material.

20. The flexible pouch of claim 19, wherein said polyolefin plastomer is a polypropylene elastomer.

21. The flexible pouch of claim 13, wherein said polypropylene polymer is formed from a monomer represented by the formula H₂C═CR₁R₂ wherein, independently, R₁ may be H or a C₂-C₆ alkyl group, and R₂ is H, a C₂-C₆ alkyl group, or a C(O)OR₃ group wherein R₃ is H or a C₂-C₆ alkyl group.

22. The flexible pouch of claim 13, wherein said polyethylene sealant film is comprised of low density polyethylene (LDPE), linear low density polyethylene (LLDPE), linear medium density polyethylene (LMDPE), linear very low density polyethylene (VLDPE), linear ultra low density polyethylene (ULDPE), metallacene linear low density polyethylene (MLLDPE), high density polyethylene (HDPE), Polyolefin Plastomer (PO), or mixtures thereof.

23. The flexible pouch of claim 13, wherein said polyolefin elastomer is present in said polyethylene sealant film in an amount of from about 1 to about 25 percent by weight.

24. The flexible pouch of claim 13, further including as one or more additional layers intermediate said outer layers foil, nylon, polyvinylidene chloride, polyethylene terephthalate, oriented polypropylene, ethylene/vinyl acetate copolymers, paper, ethylene/acrylic acid copolymers, ethylene/methacrylic acid copolymers, EVOH, paper, and polyethylene.
